(19) United States
(12) Patent Application Publication
(10) Pub. No.: US 2024/0255627 A1
(43) Pub. Date: Aug. 1, 2024

(54) TECHNIQUES FOR MITIGATING CROSS-CHANNEL INTERFERENCE IN FMCW LIDAR SYSTEMS

(71) Applicant: AEVA, INC., Mountain View, CA (US)

(72) Inventors: Jose Krause Perin, Mountain View, CA (US); Kumar Bhargav Viswanatha, Santa Clara, CA (US); Rajendra Tushar Moorti, Mountain View, CA (US); Mina Rezk, Haymarket, VA (US)

(21) Appl. No.: 18/104,161

(22) Filed: Jan. 31, 2023

(51) Int. Cl. G01S 7/493

(52) U.S. Cl. CPC G01S 7/493

(57) ABSTRACT

A first signal at a first channel and a second signal at a second channel are received at the LiDAR system. A frequency of a crosstalk signal in a detection of the second signal is determined based on the first signal. An intensity of the crosstalk signal is determined based on the intensity of the first signal. Provided the intensity of the crosstalk signal is in a detectable range, the crosstalk signal is excluded from the detection of the second signal to produce a corrected second signal, to extract the at least one of range or velocity information related to a target based on the corrected second signal.

### TECHNICAL FIELD

The present disclosure relates generally to light detection and ranging (LiDAR) systems, for example, techniques to compensate for mitigating crosstalk between channels in coherent LiDAR systems.

### BACKGROUND

Scanning FMCW LiDAR systems may use moving scanning mirrors to steer light beams and scan targets. The target return signals may be mixed with local oscillator signals on the optical receivers (photodetectors), to extract information about range, velocity, and reflectivity measurements of the targets. However, there may be interference across different channels in the optical receivers (photodetectors) due to crosstalk or light leakage. These interfering signals could affect the targets detected by the optical receivers (photodetectors), leading to the appearance of the “ghost” targets, i.e., targets not present in the actual scene.

### SUMMARY

The present disclosure describes various examples, without limitation, methods of processing signal in LiDAR systems.

In some examples, disclosed herein are techniques of compensating for mitigating cross-channel interference in coherent LiDAR systems. For example, channel 1 detects target 1 at frequency f1, while channel 2 detects target 2 at frequency f2. Due to crosstalk, channel 2 may also detect a ghost signal at frequency f1, which may result in a ghost target in the point cloud. For example, the frequency of a crosstalk signal (ghost detection) may be determined to appear at the same frequency f1 as the source of crosstalk. As an example, the crosstalk signal may be the unwanted signal at frequency f1 transferred from channel 1 to channel 2. The crosstalk signal may also result from an optical leakage. If the resulting crosstalk intensity is in the detectable range, the crosstalk signal is excluded by the various techniques performed by various embodiments of the present disclosure disclosed herein. In one example, at the peak selection level, a band of frequencies around f1 may be ignored so that the crosstalk peak is not detected. In another example, at the peak selection level, a higher noise limit around frequency f1, which is a function of the intensity of crosstalk, may be applied. In still another example, at the point cloud processing level, any detections that appear at or close to frequency f1, and with intensity similar to the one predicted by the crosstalk model, may be discarded. By this way, the interfering signals are avoided or discarded when making detections. Thus, the accuracy in range, velocity, and reflectivity measurements of the target is increased.

In some examples, a method of compensating for mitigating cross-channel interference in a LiDAR system is disclosed herein. A first signal at a first channel and a second signals at a second channel are received at the LiDAR system. A frequency of a crosstalk signal in a detection of the second signal is determined based on the first signal. An intensity of the crosstalk signal is determined based on an intensity of the first signal. Provided the intensity of the crosstalk signal is in a detectable range, the crosstalk signal is excluded from the detection of the second signal to produce a corrected second signal, to extract the at least one of range or velocity information related to a target based on the corrected second signal.

In some examples, a LiDAR system is disclosed herein. The LiDAR system comprises a processor and a memory to store instructions that, when executed by the processor, cause the system to receive a first signal at a first channel and a second signal at a second channel. The LiDAR system is further to determine a frequency of a crosstalk signal in a detection of the second signal based on the first signal. The LiDAR system is further to determine an intensity of the crosstalk signal based on an intensity of the first signal. Provided the intensity of the crosstalk signal is in a detectable range, the LiDAR system is further to exclude the crosstalk signal from the detection of the second signal to produce corrected second signals, to extract the at least one of range or velocity information related to a target based on the corrected second signals.

In some examples, a LiDAR system is disclosed herein. The LiDAR system comprises an optical source to emit an optical beam, one or more optical receivers to receive a first signal at a first channel and a second signal at a second channel. The LiDAR system further comprises a circuitry; and a memory to store instructions that, when executed by the circuitry, cause the system to: determine a frequency of a crosstalk signal in a detection of the second signal based on the first signal; determine an intensity of the crosstalk signal based on an intensity of the first signal; and provided the intensity of the crosstalk signal is in a detectable range, exclude the crosstalk signal from the detection of the second signal to produce corrected second signals, to extract the at least one of range or velocity information related to a target based on the corrected second signals.

These and other aspects of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and examples, should be viewed as combinable unless the context of the disclosure clearly dictates otherwise.

It will therefore be appreciated that this Summary is provided merely for purposes of summarizing some examples so as to provide a basic understanding of some aspects of the disclosure without limiting or narrowing the scope or spirit of the disclosure in any way. Other examples, aspects, and advantages will become apparent from the following detailed description taken in conjunction with the accompanying figures which illustrate the principles of the described examples.

### BRIEF DESCRIPTION OF THE DRAWINGS

For a more complete understanding of various examples, reference is now made to the following detailed description taken in connection with the accompanying drawings in which like identifiers correspond to like elements:

FIG. 1A is a block diagram illustrating an example LiDAR system according to embodiments of the present disclosure.

FIG. 1B is a block diagram illustrating an example of a crosstalk module of a LiDAR system according to embodiments of the present disclosure.

FIG. 2 is a time-frequency diagram illustrating an example of FMCW LiDAR waveforms according to embodiments of the present disclosure.

FIG. 3A is a diagram illustrating an example of a crosstalk in the LiDAR system 100, according to embodiments of the present disclosure.

FIG. 3B is a diagram illustrating an example of the LiDAR system 100 having electronic crosstalk, according to embodiments of the present disclosure.

FIGS. 4A-4B are diagrams illustrating how the various embodiments described herein can measure signal intensities in different channels in a LiDAR system to identify sources of crosstalks in order to mitigate them, according to embodiments of the present disclosure.

FIG. 5 is a diagram illustrating an example of a process of mitigating cross-channel interference from electronic crosstalk in a LiDAR system, according to embodiments of the present disclosure.

FIG. 6 is a diagram illustrating an example of an optical leakage in a LiDAR system, according to embodiments of the present disclosure.

FIG. 7 is a diagram illustrating an example of a process of mitigating cross-channel interference from optical leakage in a LiDAR system, according to embodiments of the present disclosure.

FIG. 8 is a diagram illustrating a method of mitigating cross-channel interference in a LiDAR system, according to embodiments of the present disclosure.

### DETAILED DESCRIPTION

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosures.

The described LiDAR systems herein may be implemented in any sensing market, such as, but not limited to, transportation, manufacturing, metrology, medical, virtual reality, augmented reality, and security systems. According to some embodiments, the described LiDAR system may be implemented as part of a front-end of frequency modulated continuous-wave (FMCW) device that assists with spatial awareness for automated driver assist systems, or self-driving vehicles.

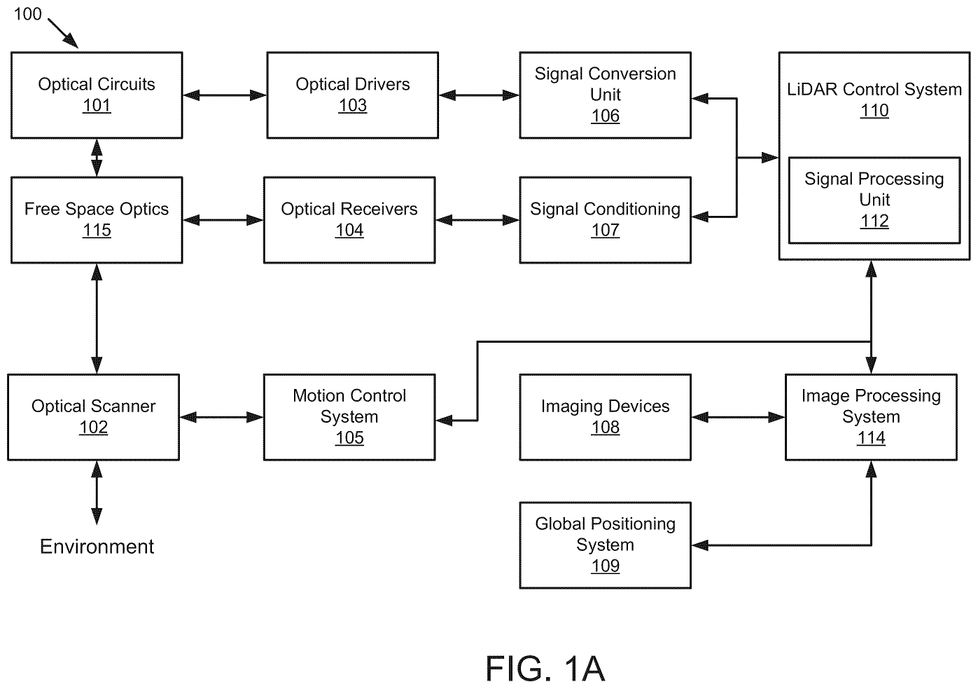

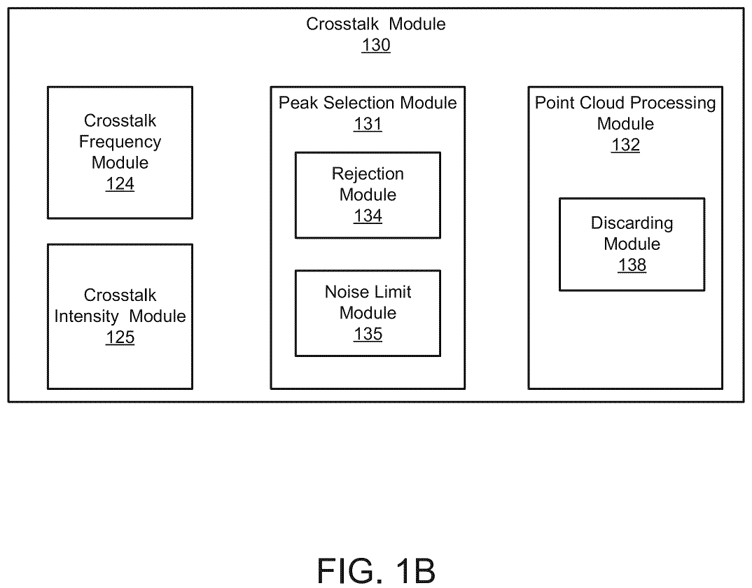

FIG. 1A illustrates a LiDAR system 100 according to example implementations of the present disclosure. The LiDAR system 100 includes one or more of each of a number of components, but may include fewer or additional components than shown in FIG. 1A. According to some embodiments, one or more of the components described herein with respect to LiDAR system 100 can be implemented on a photonics chip. The optical circuits 101 may include a combination of active optical components and passive optical components. Active optical components may generate, amplify, and/or detect optical signals and the like. In some examples, the active optical component includes optical beams at different wavelengths, and includes one or more optical amplifiers, one or more optical detectors, or the like.

Free space optics 115 may include one or more optical waveguides to carry optical signals, and route and manipulate optical signals to appropriate input/output ports of the active optical circuit. The free space optics 115 may also include one or more optical components such as taps, wavelength division multiplexers (WDM), splitters/combiners, polarization beam splitters (PBS), collimators, couplers or the like. In some examples, the free space optics 115 may include components to transform the polarization state and direct received polarized light to optical detectors using a PBS, for example. The free space optics 115 may further include a diffractive element to deflect optical beams having different frequencies at different angles.

In some examples, the LiDAR system 100 includes an optical scanner 102 that includes one or more scanning mirrors that are rotatable along an axis (e.g., a slow-moving-axis) that is orthogonal or substantially orthogonal to the fast-moving-axis of the diffractive element to steer optical signals to scan a target environment according to a scanning pattern. For instance, the scanning mirrors may be rotatable by one or more galvanometers. Objects in the target environment may scatter an incident light into a return optical beam or a target return signal. The optical scanner 102 also collects the return optical beam or the target return signal, which may be returned to the passive optical circuit component of the optical circuits 101. For example, the return optical beam may be directed to an optical detector by a polarization beam splitter. In addition to the mirrors and galvanometers, the optical scanner 102 may include components such as a quarter-wave plate, lens, anti-reflective coating window or the like.

To control and support the optical circuits 101 and optical scanner 102, the LiDAR system 100 includes LiDAR control systems 110. The LiDAR control systems 110 may include a processing device for the LiDAR system 100. In some examples, the processing device may be one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. The processing device may also be one or more special-purpose processing devices such as an application specific integrated circuit (ASIC), a field programmable gate array (FPGA), a digital signal processor (DSP), network processor, or the like.

In some examples, the LiDAR control systems 110 may include a signal processing unit 112 such as a digital signal processor (DSP). The LiDAR control systems 110 are configured to output digital control signals to control optical drivers 103. In some examples, the digital control signals may be converted to analog signals through signal conversion unit 106. For example, the signal conversion unit 106 may include a digital-to-analog converter. The optical drivers 103 may then provide drive signals to active optical components of optical circuits 101 to drive optical sources such as lasers and amplifiers. In some examples, several optical drivers 103 and signal conversion units 106 may be provided to drive multiple optical sources.

The LiDAR control systems 110 are also configured to output digital control signals for the optical scanner 102. A motion control system 105 may control the galvanometers of the optical scanner 102 based on control signals received from the LiDAR control systems 110. For example, a digital-to-analog converter may convert coordinate routing information from the LiDAR control systems 110 to signals interpretable by the galvanometers in the optical scanner 102. In some examples, a motion control system 105 may also return information to the LiDAR control systems 110 about the position or operation of components of the optical scanner 102. For example, an analog-to-digital converter may in turn convert information about the galvanometers' position to a signal interpretable by the LiDAR control systems 110.

The LiDAR control systems 110 are further configured to analyze incoming digital signals. In this regard, the LiDAR system 100 includes optical receivers 104 to measure one or more beams received by optical circuits 101. For example, a reference beam receiver may measure the amplitude of a reference beam from the active optical component, and an analog-to-digital converter converts signals from the reference receiver to signals interpretable by the LiDAR control systems 110. Target receivers measure the optical signal that carries information about the range and velocity of a target in the form of a beat frequency, modulated optical signal. The reflected beam may be mixed with a second signal from a local oscillator. The optical receivers 104 may include a high-speed analog-to-digital converter to convert signals from the target receiver to signals interpretable by the LiDAR control systems 110. In some examples, the signals from the optical receivers 104 may be subject to signal conditioning by signal conditioning unit 107 prior to receipt by the LiDAR control systems 110. For example, the signals from the optical receivers 104 may be provided to an operational amplifier for amplification of the received signals and the amplified signals may be provided to the LiDAR control systems 110.

In some applications, the LiDAR system 100 may additionally include one or more imaging devices 108 configured to capture images of the environment, a global positioning system 109 configured to provide a geographic location of the system, or other sensor inputs. The LiDAR system 100 may also include an image processing system 114. The image processing system 114 can be configured to receive the images and geographic location, and send the images and location or information related thereto to the LiDAR control systems 110 or other systems connected to the LiDAR system 100.

In operation according to some examples, the LiDAR system 100 is configured to use nondegenerate optical sources to simultaneously measure range and velocity across two dimensions. This capability allows for real-time, long range measurements of range, velocity, azimuth, and elevation of the surrounding environment.

In some examples, the scanning process begins with the optical drivers 103 and LiDAR control systems 110. The LiDAR control systems 110 instruct the optical drivers 103 to independently modulate one or more optical beams, and these modulated signals propagate through the passive optical circuit to the collimator. The collimator directs the light at the optical scanning system that scans the environment over a preprogrammed pattern defined by the motion control system 105. The optical circuits 101 may also include a polarization wave plate (PWP) to transform the polarization of the light as it leaves the optical circuits 101. In some examples, the polarization wave plate may be a quarter-wave plate or a half-wave plate. A portion of the polarized light may also be reflected back to the optical circuits 101. For example, lensing or collimating systems used in LiDAR system 100 may have natural reflective properties or a reflective coating to reflect a portion of the light back to the optical circuits 101.

Optical signals reflected back from the environment pass through the optical circuits 101 to the receivers. Because the polarization of the light has been transformed, it may be reflected by a polarization beam splitter along with the portion of polarized light that was reflected back to the optical circuits 101. Accordingly, rather than returning to the same fiber or waveguide as an optical source, the reflected light is reflected to separate optical receivers. These signals interfere with one another and generate a combined signal. Each beam signal that returns from the target produces a time-shifted waveform. The temporal phase difference between the two waveforms generates a beat frequency measured on the optical receivers (photodetectors). The combined signal can then be reflected to the optical receivers 104.

The analog signals from the optical receivers 104 are converted to digital signals using ADCs. The digital signals are then sent to the LiDAR control systems 110. A signal processing unit 112 may then receive the digital signals and interpret them. In some embodiments, the signal processing unit 112 also receives position data from the motion control system 105 and galvanometers (not shown) as well as image data from the image processing system 114. The signal processing unit 112 can then generate a 3D point cloud with information about range and velocity of points in the environment as the optical scanner 102 scans additional points. The signal processing unit 112 can also overlay a 3D point cloud data with the image data to determine velocity and distance of objects in the surrounding area. The system also processes the satellite-based navigation location data to provide a precise global location.

Referring to FIG. 1B, which is a block diagram illustrating an example of a crosstalk module 130 of the LiDAR system 100 according to embodiments of the present disclosure. In one embodiment, the signal processing unit 112 may include the crosstalk module 130. It should be noted that, although the crosstalk module may reside within the signal processing unit 112, embodiments of the present disclosure are not limited as such. For instance, the crosstalk module 130 can reside in computer memory (e.g., RAM, ROM, flash memory, and the like) within system 100 (e.g., LiDAR control system 110). The crosstalk module 130 may include, but not being limited to, a crosstalk frequency module 124, a crosstalk intensity module 125, a peak selection module 131 including a rejection module 134 and a noise limit module 135, and a point cloud processing module 132 including a discarding module 138. In some embodiments, the crosstalk module 130 may receive signals from the optical source through the optical receivers 104 or the signal conditioning unit 107 depicted in FIG. 1A.

For instance in one scenario, channel 1 may detect target 1 at frequency f1, while channel 2 may detect target 2 at frequency f2. Due to crosstalk, channel 2 may also detect a ghost signal in f1, which may be an unwanted signal transferred from channel 1 to channel 2. The ghost signal may be referred as a “crosstalk signal,” which may result in a false detection (ghost target) in the point cloud. The crosstalk frequency module 124 is configured to determine the frequency of a crosstalk signal (ghost detection). For example, the frequency of the crosstalk signal may be determined to appear at the same frequency f1 as the source of crosstalk. The crosstalk intensity module 125 is configured to determine the intensity of crosstalk detection which is related to the source by the coupling coefficient. The coupling coefficient is a function of the frequency f1 of the target 1 and can be obtained by calibration. If the resulting crosstalk intensity is in the detectable range, at the peak selection level, the rejection module 134 may ignore a band of frequencies around the frequency f1 so that the crosstalk peak is not detected, or the noise limit module 135 may apply a higher noise limit around the frequency f1 which is a function of the intensity of crosstalk detection. At the point cloud processing level, the discarding module 138 may discard any detections that appear at or close to the frequency f1 and with intensity similar to the one predicted by the crosstalk model. By this way, the interfering signals are avoided or discarded when making detections. Thus, the accuracy in range, velocity, and reflectivity measurements of the target is increased.

It should be appreciated that the components depicted may be implemented in software, hardware, or a combination thereof. For example, these modules may be loaded into a memory, and executed by one or more processors. Some of the depicted components may be integrated together as an integrated module resident on the LiDAR systems described herein.

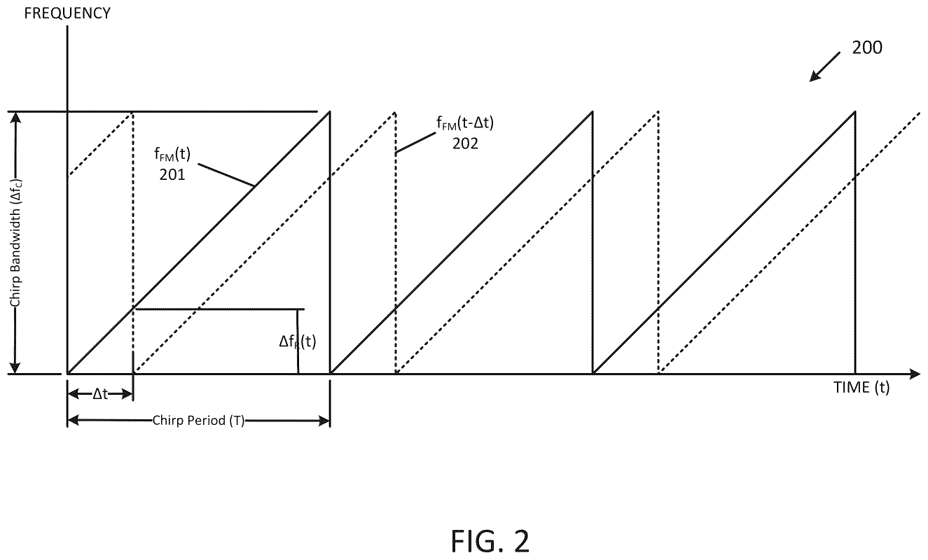

FIG. 2 is a time-frequency diagram 200 of an FMCW scanning signal 101b that can be used by a LiDAR system, such as system 100, to scan a target environment according to some embodiments. In one example, the scanning waveform 201, labeled as f_{FM}(t), is a sawtooth waveform (sawtooth “chirp”) with a chirp bandwidth Δf_{C} and a chirp period T_{C}. The slope of the sawtooth is given as k=(Δf_{C}/T_{C}). FIG. 2 also depicts target return signal 202 according to some embodiments. Target return signal 202, labeled as f_{FM}(t-Δt), is a time-delayed version of the scanning signal 201, where Δt is the round trip time to and from a target illuminated by scanning signal 201. The round trip time is given as Δt=2R/v, where R is the target range and v is the velocity of the optical beam, which is the speed of light c. The target range, R, can therefore be calculated as R=c(Δt/2). When the return signal 202 is optically mixed with the scanning signal, a range-dependent difference frequency (“beat frequency”) Δf_{R}(t) is generated. The beat frequency Δf_{R}(t) is linearly related to the time delay Δt by the slope of the sawtooth k. That is, Δf_{R}(t)=kΔt. Since the target range R is proportional to Δt, the target range R can be calculated as R=(c/2)(Δf_{R}(t)/k). That is, the range R is linearly related to the beat frequency Δf_{R}(t). The beat frequency Δf_{R}(t) can be generated, for example, as an analog signal in optical receivers 104 of system 100. The beat frequency can then be digitized by an analog-to-digital converter (ADC), for example, in a signal conditioning unit such as signal conditioning unit 107 in LiDAR system 100. The digitized beat frequency signal can then be digitally processed, for example, in a signal processing unit, such as signal processing unit 112 in system 100. It should be noted that the target return signal 202 will, in general, also include a frequency offset (Doppler shift) if the target has a velocity relative to the LiDAR system 100. The Doppler shift can be determined separately, and used to correct the frequency of the return signal, so the Doppler shift is not shown in FIG. 2 for simplicity and ease of explanation. It should also be noted that the sampling frequency of the ADC will determine the highest beat frequency that can be processed by the system without aliasing. In general, the highest frequency that can be processed is one-half of the sampling frequency (i.e., the “Nyquist limit”). In one example, and without limitation, if the sampling frequency of the ADC is 1 gigahertz, then the highest beat frequency that can be processed without aliasing (Δf_{Rmax}) is 500 megahertz. This limit in turn determines the maximum range of the system as Rₘₐₓ=(c/2)(Δf_{Rmax}/k) which can be adjusted by changing the chirp slope k. In one example, while the data samples from the ADC may be continuous, the subsequent digital processing described below may be partitioned into “time segments” that can be associated with some periodicity in the LiDAR system 100. In one example, and without limitation, a time segment might correspond to a predetermined number of chirp periods T, or a number of full rotations in azimuth by the optical scanner.

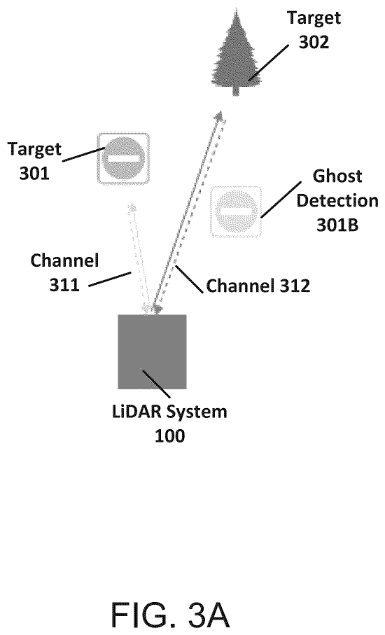

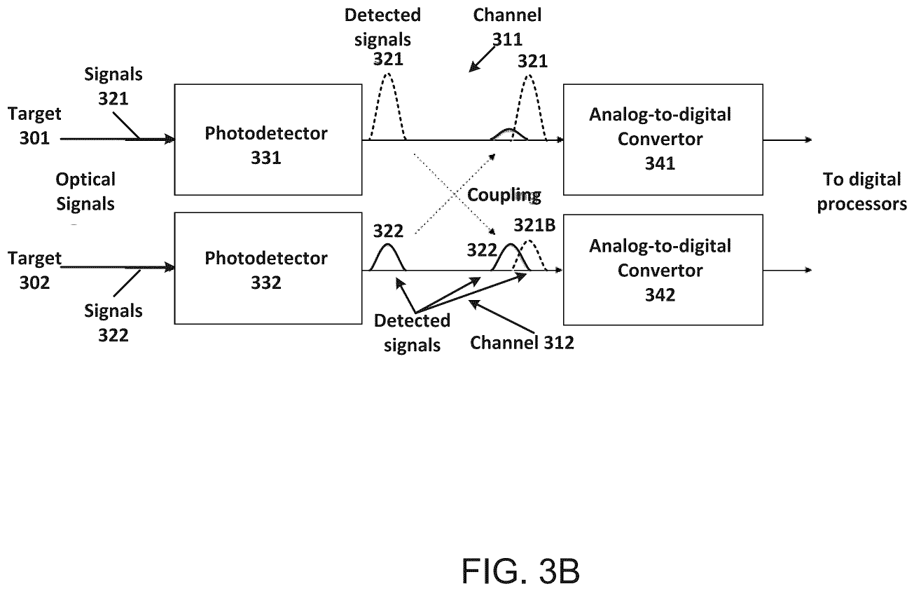

FIG. 3A diagrams illustrating an example of crosstalk in the LiDAR system 100, according to embodiments of the present disclosure. For some optical receivers (photodetectors, e.g., optical receivers 104), signals propagate in close proximity to other channels. There may be some non-negligible amount of coupling between adjacent channels. Thus, there may be interference across different channels in the optical receivers (e.g., photodetectors), due to the crosstalk.

As depicted in FIG. 3A, the LiDAR system 100 may be configured to receive signals in channel 311 from a target 301 and receive signals in a channel 312 from a target 302. However, in some scenarios, the signals in the channel 311 and the signals in the channel 312 may propagate in close proximity to each other. As a result, there may be some amount of coupling between channel 311 and channel 312 which causes a subset of signals from signals transferred from the channel 311 to the channel 312. The unwanted signals transferred from the channel 311 to the channel 312 may be referred as crosstalk signals, which may result in a ghost detection (false detection) 301B.

FIG. 3B is a diagram illustrating an example of the LiDAR system 100 having electronic crosstalk, according to embodiments of the present disclosure. Referring to FIG. 3B, a photodetector 331 in a channel 311 between the photodetector 331 and the ADC 341 is configured to receive signals 321, e.g., from the target 301 in FIG. 3A, while a photodetector 332 in a channel 312 between the photodetector 331 and the ADC 341 is configured to receive signals 322, e.g., from the target 302 in FIG. 3A. The channel 311 may detect the target 301 at the frequency f1, e.g., the beat frequency corresponding to the target 301, as discussed above in connection with FIG. 1A, while the channel 312 may detect the target 302 at the frequency f2, e.g., the beat frequency corresponding to the target 302, as discussed above in connection with FIG. 1A. The signals detected from components listening to the channel 311 and the channel 312 (e.g., ADC) may be converted to digitals signals by analog-to-digital converters 341, 342 respectively, and propagate to digitals processors (e.g., signal processing unit 112).

However, in some scenarios, the signals 321 in the channel 311 and the signals 321 in the channel 312 may propagate in close proximity to each other. As a result, there may be some amount of coupling between channel 311 and channel 312 which causes a subset of signals from signals 321 to be coupled to the channel 312, and a subset certain number of signals 322 to be coupled to the channel 311. For instance, As illustrated in FIG. 3B, the channel 312 may detect a certain amount of 321B which are signals 321 coupled from the channel 311 originated from the target 301, in addition to the signals 322 originated from the target 302.

In some scenarios, the coupled signals 321B may be stronger than the received signal 322. In this fashion, ADC 342 can detect the signals 322 and the coupled signals 321B. The coupled signals 321B can, in turn, cause the LiDAR system 100 to detect a “ghost” target 301B, i.e., a target that is not part of the real scene. ADC 342 in the channel 312 may detect the crosstalk signal in the frequency f1, which may result in the “ghost” target 301B in the point cloud. Given the nature of crosstalk, the “ghost” target 301B may appear at the same frequency as the source of crosstalk f1, but with a lower intensity. Because the crosstalk is produced from coupled signals, the resultant signals 321B produced from the crosstalk are attenuated while the frequency of the original signal 321 is preserved. Thus, the frequency of the crosstalk signal 321B may be determined to appear at the same frequency f1 as the source signal 321 of crosstalk.

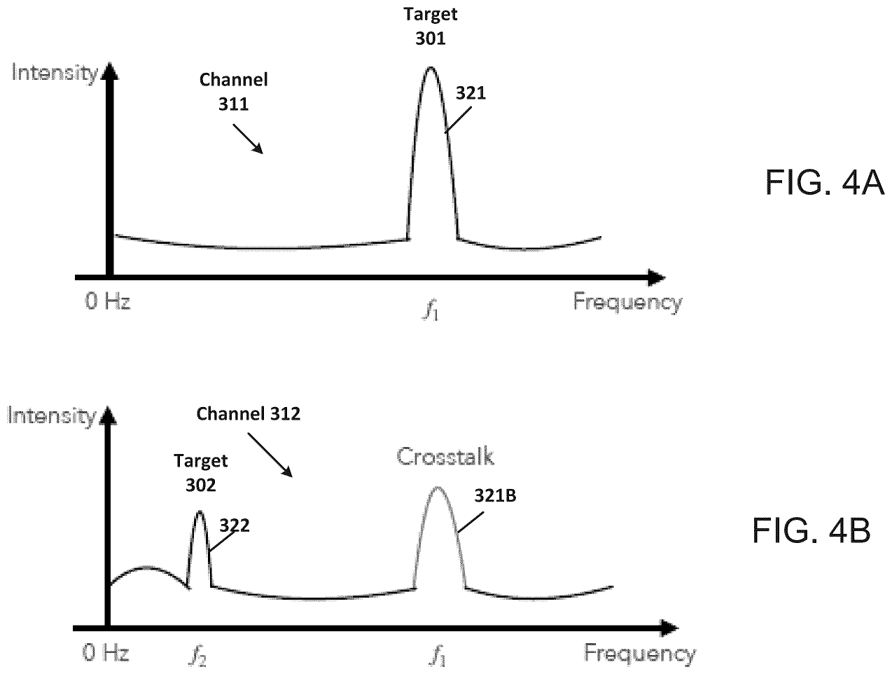

FIGS. 4A-4B are diagrams illustrating how the various embodiments described herein can measure signal intensities in different channels in a LiDAR system to identify sources of crosstalks in order to mitigate them, according to embodiments of the present disclosure. Referring to FIGS. 4A-4B, the intensity of the coupled signal 321BI_{c}, measured by the ADC 342, is related to the intensity of the signals 321 Iₛ by the coupling coefficient C(f1). The coupling coefficient C(f1) is a function of the frequency f1 of the target 301:

I_{c}=C(f1)×Iₛ

In some scenarios, the coupling coefficient C(f1) may be obtained by calibration. In some scenarios, the coupling coefficient may be obtained by embodiments of the present disclosure based on measurements performed during operation of LiDAR system 100 or while it is offline. For example, the coupling coefficient may refer to how much energy or power from a source signal is coupled to signals of a different channel. In some scenarios, the coupling coefficient C(f1) may be a number from zero to 1. For example, when the coupling coefficient C(f1) is 1, there a stronger coupling can be presumed, and all the energy of the source signal is coupled to be the crosstalk signal. If the coupling coefficient C(f1) is zero, there is very good insulation and there is no crosstalk. In optical receivers, the coupling coefficient C(f1) may be 0.001%, 0.01%, 0.1%, 1%, or any values therebetween. The crosstalk model may identify the potential sources of crosstalk signals and simulate the crosstalk signals based on the configuration of the LiDAR system.

If the intensity I_{c} of the resulting crosstalk signal, e.g., the coupled signal 321B, is in the detectable range, the crosstalk signal is excluded by the following approaches. In one example, at the peak selection level, a band of frequencies around the frequency f1 may be ignored in the detection of channel 312, so that the peak of the crosstalk signal is not detected. For example, the bandwidth of the band of frequencies may be predetermined based on a threshold intensity of the crosstalk signal.

In another example, a higher noise limit around the frequency f1 may be applied. The noise limit may be a function of the intensity of the crosstalk signal (crosstalk detection). Instead of completely blocking this region of frequencies around the frequency f1, the noise limit level may be increased. The band of frequencies around the frequency f1 may still be available for detection, however, by changing the noise limit level, a higher threshold is applied on the detections around the frequency f1 that would qualify as a true detection. For example, if a threshold of signal to noise ratio (SNR) may be typically 5 dB, then only signals with SNR higher than 5 dB may be detected by the system. At channel 312, a higher SNR threshold may be applied around the frequency f1, e.g., 10 dB, so that signals with SNR higher than 10 dB may be detected by the system. In this way, if there may be signals from a true target which are strong enough to overcome the higher threshold, the signals may be detected by the system. The higher noise limit, e.g., the higher SNR, may be determined based on the coupling coefficient. According to the coupling coefficient, the noise limit, e.g., the SNR, may be determined to be large enough to block the crosstalk signal, but not block the signals from a true target.

In still another example, at the point cloud processing level, any detections that appear at or close to the crosstalk frequency f1 and with the intensity similar as that predicted by the crosstalk model may be discarded. At the point cloud processing level, whether any detections made in one channel could be explained by other detections made in a different channel may be checked. For example, after detecting the signals 321 at channel 311, whether there is a strong detection around the frequency f1 in the channel 312 may be checked. When, at channel 312, there may be detections close to the crosstalk frequency f1 with the intensity similar to the intensity predicted by the crosstalk model, the detections may be discarded as being crosstalk signals, not a true detection.

In this way, the interfering signals are avoided or discarded when making detections. Thus, the accuracy in range, velocity, and reflectivity measurements of the target is increased.

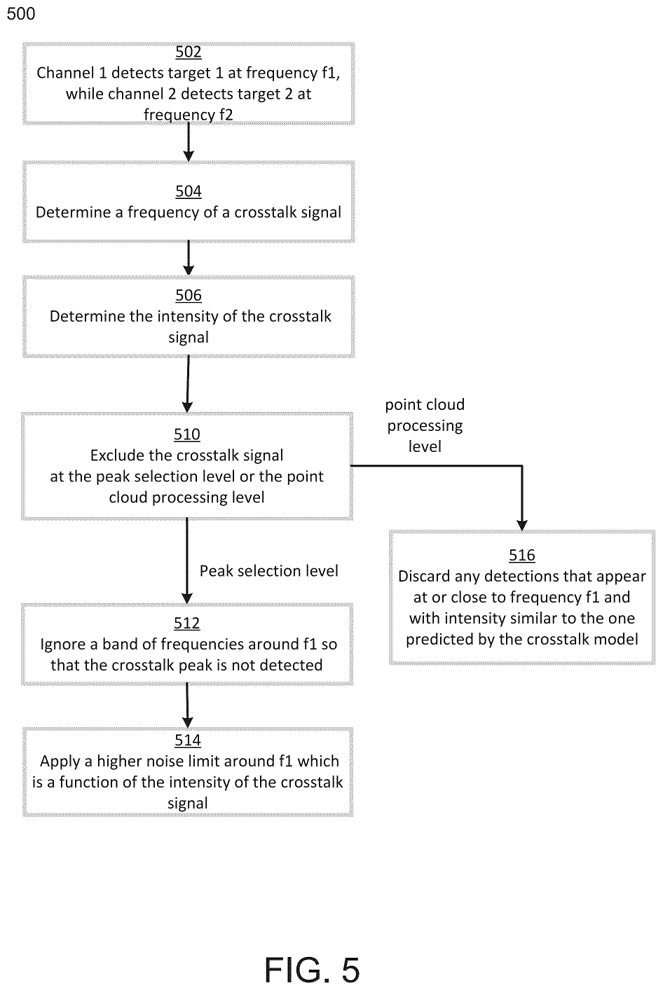

FIG. 5 is a diagram illustrating an example of a process 500 of compensating for mitigating cross-channel interference resulted from an electronic crosstalk in a LiDAR system, according to embodiments of the present disclosure. Process 500 may be performed by processing logic which may include software, hardware, or a combination thereof. The software may be stored on a non-transitory machine readable storage medium (e.g., on a memory device). For example, the process 500 may be performed by the crosstalk module 130 in the signal processing unit 112 of the LiDAR system 100, as illustrated in FIG. 1A—FIG. 1B.

At block 502, ADC 341 at channel 1 (e.g., 311) detects the signal 321 from target 1 (e.g., 301) at frequency f1, while ADC 342 at channel 2 (e.g., 312) detects the signal 322 from the target 2 (e.g., 302) at frequency f2. Due to crosstalk, the ADC 342 at channel 2 (e.g., 312) also detects a crosstalk signal (e.g., 321B). A detection at channel 2 includes the signal 322 and the crosstalk signal (e.g., 321B).

At block 504, processing logic determines a frequency of the crosstalk signal at channel 2 based on the signal 321. For example, processing logic may determine the frequency of the crosstalk signal is the frequency f1 of the signal 321 at the channel 1 (e.g., 311).

At block 506, processing logic (e.g., logic implemented by one or more processors described herein in, for example, FIG. 1A including but not limited to signal processing unit 112) measures the intensity of the crosstalk signal based on a measured intensity of the first signal and a coupling coefficient. For example, processing logic may determine a source of the crosstalk signal based on a subset of signals 321 detected at the channel 1 (e.g., 311) based on a crosstalk model. For example, the crosstalk model may be created and stored in the signal processing unit 112 in FIG. 1A. In this fashion, the crosstalk model simulates the intensity of the crosstalk signal based on the signals 321 measured at channel 1 (e.g., 311). Processing logic may determine the intensity of the crosstalk signal based on the coupling coefficient and the intensity of the signals 321 at channel 1 (e.g., 311). For example, the coupling coefficient may include a ratio of the intensity of the crosstalk signal to the intensity of the signal 321 at channel 1 (e.g., 311).

At block 510, when the intensity of the crosstalk signal is in the detectable range, the processing logic excludes a detection of the crosstalk signal from the detection of the signals 322, at the channel 2 (e.g., 312), to produce corrected signals 322, for example, by the signal processing unit 112 in FIG. 1A.

At block 512, at the peak selection level, processing logic may discard a band of frequencies of the detection of the signal 322 around the frequency of the crosstalk signal f1 so that the peak of the crosstalk signal is not detected, for example, by the signal processing unit 112 in FIG. 1A. The processing logic may discard a portion of the signals 322 in a frequency band around the frequency f1 of the crosstalk signal with a predetermined bandwidth.

At block 514, the processing logic may apply a higher noise limit around f1 which is a function of the intensity of the crosstalk signal (crosstalk detection), for example, by the signal processing unit 112 in FIG. 1A. The processing logic may apply a higher threshold of signal to noise ratio (SNR) to a portion of the detection of the second signal in a frequency band around the frequency of the crosstalk signal than another portion of the detection of the second signal. The higher threshold of SNR is determined based on the intensity of the crosstalk signal.

At block 516, at the point cloud processing level, any detections that appear at or close to the frequency f1 and with the intensity similar to the one predicted by the crosstalk model may be discarded, for example, by the signal processing unit 112 in FIG. 1A. The processing logic may discard a portion of the detection of the signal 322 in a frequency band around the frequency f1 of the crosstalk signal with an intensity similar to a predicted intensity of the crosstalk signal. For example, processing logic may discard apportion of the detection of the signal 322 in a certain bandwidth around the frequency f1 of the crosstalk signal (e.g., 0.5 kHz, 1 Kz, 2 Kz, etc.). For another example, processing logic may discard apportion of the detection of the signals 322 around the frequency f1 of the crosstalk signal within a certain percentage of the predicted intensity of the crosstalk signal (e.g., 5%, 10%, 15%, etc.). In this way, the crosstalk signal is avoided or discarded when making detections. Thus, the accuracy in range, velocity, and reflectivity measurements of the target is increased.

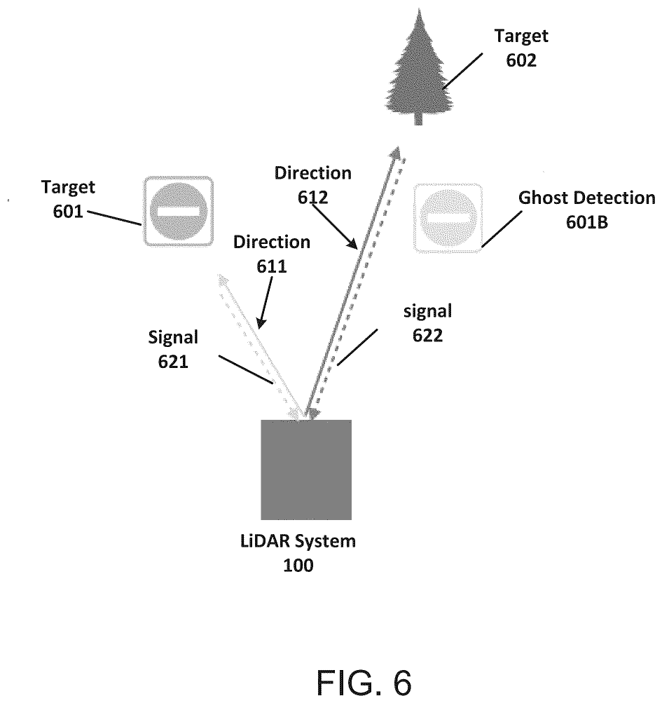

FIG. 6 is a diagram illustrating an example of an optical leakage in the LiDAR system 100, according to embodiments of the present disclosure. As discussed above, the crosstalk signal may result from the electronic signals coupling between the adjacent channels. The crosstalk signal may also result from an optical leakage. The optical leakage may happen due to multiple reasons. For example, light from one channel may leak into a separate channel in a manner similar to the cross-channel interference described herein. For instance, a portion of light may be transmitted out of the LiDAR system 100 and return to the system at a different angle than the system expects, resulting in a crosstalk signal, which may be outside of the typical field of view (FOV) of the system. In the FOV optical leakage, the angle at which the leakage light goes out of the system is within the FOV of the system.

Referring to FIG. 6, the LiDAR system 100 may transmit an optical beam towards a target 602 in a direction 612. A signal 622 returned from a target 602 from may be received by an optical receiver resident on LiDAR system 100 (not depicted). However, due to the configuration of the system, a portion of the optical beam may go out of the designed path. For example, the optical beam may be slightly larger than the scanning mirror, the portion of the optical beam not reflected by the scanning mirror may be out of the designed path. The out of the designed path optical beam may transmit along a direction 611, different from the designed direction 612. If this portion of the optical beam hits a target 601, a signal 621 may return from the target 601 to the optical receiver in the direction 611 which detects a ghost target 601B in the direction 612. In this fashion, the signal 621 contains optical leakage that interferes with the detection of the target 602. Though the portion of the optical beam out of the designed path may be only a small percentage of the optical beam, e.g., 1%, 5%, etc., however, if the target 601 is a strong reflective target, the signal 621 may have strong interference with the signal 622, resulting a ghost detection of target 601B.

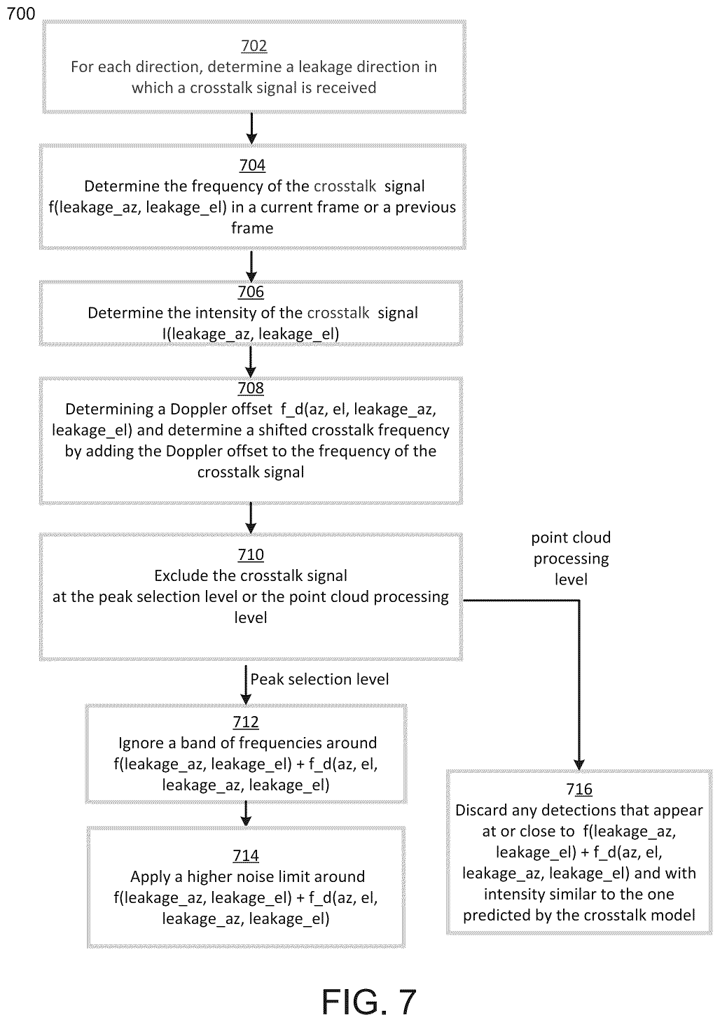

FIG. 7 is a diagram 700 illustrating an example of mitigating cross-channel interference from the optical leakage in the LiDAR system 100, according to embodiments of the present disclosure. For example, the optical leakage may be a FOV optical leakage. Process 700 may be performed by processing logic (e.g., logic implemented by one or more processors described herein in, for example, FIG. 1A including but not limited to signal processing unit 112) which may include software, hardware, or a combination thereof. The software may be stored on a non-transitory machine readable storage medium (e.g., on a memory device). For example, the process 700 may be performed by the crosstalk module 130 in the signal processing unit 112 of the LiDAR system 100, as illustrated in FIG. 1A-FIG. 1B.

At block 702, for each direction (az, el), determine a leakage direction (leakage_az, leakage_el) in which a leakage signal (crosstalk signal) is received. As illustrated in FIG. 6, the LiDAR system 100 receives the signal 622 in the direction 612 and the signal 621 in the direction 611. For the direction 612, processing logic may determine a direction in which the leakage signal (crosstalk signal) 621 is received is the direction 611, for example, based on the configuration of the LiDAR system 100, e.g., the geometry of optical system, etc. The direction 612 has an azimuth and an elevation (az, el), and the direction 611 has an azimuth and an elevation (leakage_az, leakage_az), where “az” represent the azimuth of the direction 612 and “el” represents the elevation of the direction 612, and “leakage_az” represent the azimuth of the direction 612 and “leakage_el” represents the elevation of the direction 611. For the direction 612 with its azimuth and elevation (az, el), processing logic may determine the azimuth and elevation (leakage_az, leakage_el) of the direction 611 in which a crosstalk signal or a leakage signal is received. Processing logic may receive the signal 622 from the target 602, which is the true signal, and the crosstalk or leakage signal 621 from the target 601. The detection of the signal 622 includes the signal 622 in the direction 622 and the signal 621 in the direction 611 within a FOV of an optical system of the LiDAR system 100. If not being excluded, the signal 621, which is the crosstalk or leakage signal, may result in a ghost target 601B in the detection of the target 602.

At block 704, processing logic may determine the frequency of the crosstalk signal, which may be expressed as f(leakage_az, leakage_el), based on the first signal from the first direction in a current frame or a previous frame. For example, processing logic may pick the last detection of the signal 621, the crosstalk signal or leakage signal, from the direction 611. This detection could either be from the current frame or previous frames. If the direction 611 (leakage_az, leakage_el) was not scanned, a signal close to the direction 611 may be selected.

At block 706, processing logic may determine the intensity of the crosstalk or leakage signal 621 (the crosstalk signal), which may be expressed as I(leakage_az, leakage_el). For example, processing logic may characterize the coupling factor C(az, el) between the crosstalk or leakage signal 621 and the true optical beam, i.e., the amount of optical beam that leaks into the direction 611. The coupling factor C(az, el) may be obtained by measurement or calibration. Processing logic may determine the intensity of the crosstalk or leakage signal 621 (the crosstalk signal) based on the coupling factor C(az, el) and an intensity of the outgoing optical beam I_beam.

I(leakage_az,leakage_el)=I_beamx C(az,el)

At block 708, processing logic may characterize the Doppler relationship between the signal 622 in the direction 612 (az, el) and the crosstalk signal or leakage signal 621 in the direction 611 (leakage_az, leakage_el) and determine a Doppler offset f_d(az, el, leakage_az, leakage_el). The characterization may depend on the scanning mechanism and the additional Doppler shift the crosstalk signal or leakage signal 621 may experience. The signals in different directions may have different Doppler shifts. For example, the signal 621 in the direction 611 may be associated with a Doppler shift, whereas the signal 622 in the direction 612 may be associated with a different Doppler shift. The Doppler offset f_d(az, el, leakage_az, leakage_el) may be determined based on a difference between the Doppler shift of the signal 622 in the direction 612 (az, el) and the different Doppler shift of the crosstalk signal or leakage signal 621 in the direction 611 (leakage_az, leakage_el). Processing logic may further determine a shifted crosstalk frequency by adding the Doppler offset to the frequency of the crosstalk signal. The shifted crosstalk frequency may be expressed as:

f_shifted_crosstalk=f(leakage_az,leakage_el)+f_d(az,el,leakage_az,leakage_el)

At block 710, if the intensity of the resulting crosstalk or leakage signal 621, which is I(leakage_az, leakage_el), is in the detectable range, processing logic may exclude the crosstalk signal or leakage signal 621 at the peak selection level or the point cloud processing level.

At block 712, at the peak selection level, processing logic may discard a band of frequencies of the detection of the signal 622 around the shifted crosstalk frequency f(leakage_az, leakage_el)+f_d(az, el, leakage_az, leakage_el) so that the peak of the crosstalk signal is not detected. Processing logic may discard a portion of the detection of the signal 622 in a frequency band around the shifted crosstalk frequency of the crosstalk signal with a predetermined bandwidth.

At block 714, processing logic may apply a higher noise limit around the shifted crosstalk frequency f(leakage_az, leakage_el)+f_d(az, el, leakage_az, leakage_el). The noise limit may be a function of the intensity of the crosstalk signal I(leakage_az, leakage_el). Processing logic may apply a threshold of signal to noise ratio (SNR) to a portion of the detection of the signal 622 in a frequency band around the shifted crosstalk frequency higher than that to other portion of the signal. The higher threshold of SNR is determined based on the intensity of the crosstalk signal.

At block 716, at the point cloud processing level, any detections that appear at or close to the shifted crosstalk frequency f(leakage_az, leakage_el)+f_d(az, el, leakage_az, leakage_el) and with the intensity similar to the one predicted by the crosstalk model may be discarded. Processing logic may discard a portion of the detection of the signal 622 in a frequency band around the shifted crosstalk frequency with an intensity similar to a predicted intensity of the crosstalk signal. For example, processing logic may discard a portion of the detection of the signal 622 in a certain bandwidth around the shifted crosstalk frequency (e.g., 0.5 kHz, 1 Kz, 2 Kz, etc.). For another example, processing logic may discard a portion of the detection of the signal 622 around the frequency f1 of the crosstalk signal within a certain percentage of the predicted intensity of the crosstalk signal (e.g., 5%, 10%, 15%, etc.).

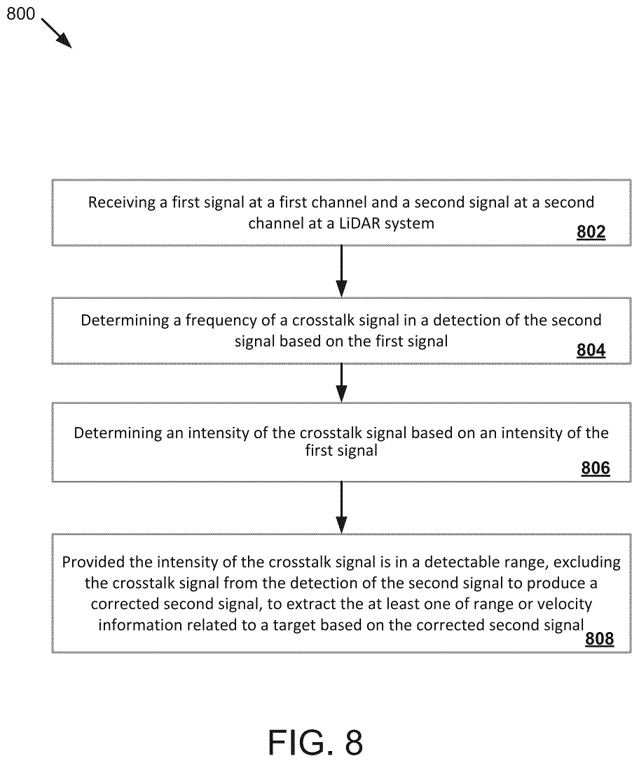

FIG. 8 is a diagram illustrating a method of compensating for mitigating cross-channel interference in a LiDAR system, according to embodiments of the present disclosure. Process 800 may be performed by processing logic (e.g., logic implemented by one or more processors described herein in, for example, FIG. 1A including but not limited to signal processing unit 112), which may include software, hardware, or a combination thereof. The software may be stored on a non-transitory machine readable storage medium (e.g., on a memory device). For example, the process 800 may be performed by the Crosstalk module 130 in the signal processing unit 112 of the LiDAR system 100, as illustrated in FIG. 1A—FIG. 1B.

At block 802, the method includes receiving a first signal at a first channel and a second signal at a second channel at the LiDAR system. At block 804, the method includes determining a frequency of a crosstalk signal in a detection of the second signal based on the first signal. At block 806, the method includes determining an intensity of the crosstalk signal based on an intensity of the first signal. At block 808, the method includes, provided the intensity of the crosstalk signal is in a detectable range, excluding the crosstalk signal from the detection of the second signal to produce a corrected second signal, to extract the at least one of range or velocity information related to a target based on the corrected second signal.

In this way, the crosstalk signal or leakage signal is avoided or discarded when making detections. Thus, the accuracy in range, velocity, and reflectivity measurements of the target is increased.

The preceding description sets forth numerous specific details such as examples of specific systems, components, methods, and so forth, in order to provide a thorough understanding of several examples in the present disclosure. It will be apparent to one skilled in the art, however, that at least some examples of the present disclosure may be practiced without these specific details. In other instances, well-known components or methods are not described in detail or are presented in simple block diagram form in order to avoid unnecessarily obscuring the present disclosure. Thus, the specific details set forth are merely exemplary. Particular examples may vary from these exemplary details and still be contemplated to be within the scope of the present disclosure.

Any reference throughout this specification to “one example” or “an example” means that a particular feature, structure, or characteristic described in connection with the examples are included in at least one example. Therefore, the appearances of the phrase “in one example” or “in an example” in various places throughout this specification are not necessarily all referring to the same example.

Although the operations of the methods herein are shown and described in a particular order, the order of the operations of each method may be altered so that certain operations may be performed in an inverse order or so that certain operation may be performed, at least in part, concurrently with other operations. Instructions or sub-operations of distinct operations may be performed in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Furthermore, the terms “first,” “second,” “third,” “fourth,” etc. as used herein are meant as labels to distinguish among different elements and may not necessarily have an ordinal meaning according to their numerical designation.

What is claimed is:

1. A method in a light detection and ranging (LiDAR) system, comprising:
receiving a first signal at a first channel and a second signal at a second channel at the LiDAR system;
determining a frequency of a crosstalk signal in a detection of the second signal based on the first signal;
determining an intensity of the crosstalk signal based on an intensity of the first signal; and
provided the intensity of the crosstalk signal is in a detectable range, excluding the crosstalk signal from the detection of the second signal to produce a corrected second signal, to extract the at least one of range or velocity information related to a target based on the corrected second signal.

2. The method of claim 1, wherein the first signal and the second signal are electronic signals, the method further comprising determining the crosstalk signal in the detection of the second signal includes a portion of the first signal coupled into the second channel.

3. The method of claim 2, further comprising determining a source of the crosstalk signal being the first signal based on a crosstalk model, and wherein the determining the frequency of the crosstalk signal in the detection of the second signal based on the first signal comprises determining the frequency of the crosstalk signal in the detection of the second signal being a frequency of the first signal.

4. The method of claim 2, wherein the determining the intensity of the crosstalk signal based on the intensity of the first signal comprises determining the intensity of the crosstalk signal based on the intensity of the first signal and a coupling coefficient, the coupling coefficient being a function of the frequency of the first signal.

5. The method of claim 2, wherein the excluding the crosstalk signal from the detection of the second signal comprises, in a peak selection process, discarding a portion of the detection of the second signal in a frequency band around the frequency of the crosstalk signal with a predetermined bandwidth.

6. The method of claim 2, wherein the excluding the crosstalk signal from the detection of the second signal comprises, in a peak selection process, applying a threshold of signal to noise ratio (SNR) to a portion of the detection of the second signal in a frequency band around the frequency of the crosstalk signal higher than that to other portion of the detection of the second signal, wherein the threshold of SNR is determined based on the intensity of the crosstalk signal.

7. The method of claim 2, wherein the excluding the crosstalk signal from the detection of the second signal comprises, at a point cloud processing, discarding a portion of the detection of the second signal in a frequency band around the frequency of the crosstalk signal with an intensity similar to a predicted intensity of the crosstalk signal.

8. The method of claim 1, wherein the first signal and the second signal are optical signals, the method further comprising determining the crosstalk signal includes the first signal from a first direction within a field of view of the LiDAR system, wherein the first channel is associated with the first direction, and the second channel is associated with a second direction.

9. The method of claim 8, further comprising, for the second direction, determining the first direction in which the crosstalk signal is received, wherein the determining the frequency of the crosstalk signal in the detection of the second signal based on the first signal comprises determining the frequency of the crosstalk signal in the detection of the second signal based on the first signal in a current frame or a previous frame.

10. The method of claim 8, wherein the first direction is associated with a first Doppler shift, wherein the second direction is associated with a second Doppler shift, the method further comprising determining a Doppler offset based on a difference between the first Doppler shift and the second Doppler shift, and determining a shifted crosstalk frequency by adding the Doppler offset to the frequency of the crosstalk signal.

11. The method of claim 10, wherein the excluding the crosstalk signal from the detection of the second signal comprises, in a peak selection process, discarding a portion of the detection of the second signal in a frequency band around the shifted crosstalk frequency with a predetermined bandwidth.

12. The method of claim 10, wherein the excluding the crosstalk signal from the detection of the second signal comprises, in a peak selection process, applying a threshold of SNR to a portion of the detection of the second signal in a frequency band around the shifted crosstalk frequency higher than that to other portion of the detection of the second signal, wherein the threshold of SNR is determined based on the intensity of the crosstalk signal.

13. The method of claim 10, wherein the excluding the crosstalk signal from the detection of the second signal comprises, at a point cloud processing, discarding a portion of the detection of the second signal in a frequency band around the shifted crosstalk frequency with an intensity similar to a predicted intensity of the crosstalk signal.

14. A light detection and ranging (LiDAR) system, comprising:
a processor; and
a memory to store instructions that, when executed by the processor, cause the LiDAR system to:
receive a first signal at a first channel and a second signal at a second channel;
determine a frequency of a crosstalk signal in a detection of the second signal based on the first signal;
determine an intensity of the crosstalk signal based on an intensity of the first signal; and
provided the intensity of the crosstalk signal is in a detectable range, exclude the crosstalk signal from the detection of the second signal to produce a corrected second signal, to extract the at least one of range or velocity information related to a target based on the corrected second signal.

15. The LiDAR system of claim 14, wherein the first signal and the second signal are electronic signals, and wherein the LiDAR system is further to determine the crosstalk signal in the detection of the second signal includes a portion of the first signal coupled into the second channel.

16. The LiDAR system of claim 15, wherein the LiDAR system is further to
in a peak selection process, discard a portion of the detection of the second signal in a frequency band around the frequency of the crosstalk signal with a predetermined bandwidth; or
in a peak selection process, apply a higher threshold of signal to noise ratio (SNR) to a portion of the detection of the second signal in a frequency band around the frequency of the crosstalk signal than other portion of the second signal; or
at a point cloud processing, discard a portion of the detection of the second signal in a frequency band around the frequency of the crosstalk signal with an intensity similar to a predicted intensity of the crosstalk signal.

17. The LiDAR system of claim 14, wherein the first signal and the second signal are optical signals, and wherein the LiDAR system is further to
determine the crosstalk signal includes the first signal from a first direction within a field of view of the LiDAR system, wherein the first channel is associated with the first direction, and the second channel is associated with a second direction.

18. The LiDAR system of claim 17, wherein the first direction is associated with a first Doppler shift, wherein the second direction is associated with a second Doppler shift, and wherein the LiDAR system is further to determine a Doppler offset based on a difference between the first Doppler shift and the second Doppler shift, and determine a shifted crosstalk frequency by adding the Doppler offset to the frequency of the crosstalk signal.

19. The LiDAR system of claim 18, wherein the LiDAR system is further to in a peak selection process, discard a portion of the detection of the second signal in a frequency band around the shifted crosstalk frequency with a predetermined bandwidth; or,
in a peak selection process, apply a threshold of SNR to a portion of the detection of the second signal in a frequency band around the shifted crosstalk frequency higher than that to other portion of the detection of the second signal; or
at a point cloud processing, discard a portion of the detection of the second signal in a frequency band around the shifted crosstalk frequency with an intensity similar to a predicted intensity of the crosstalk signal.

20. A light detection and ranging (LiDAR) system, comprising:
an optical source to emit an optical beam;
one or more optical receivers to receive a first signal at a first channel and a second signal at a second channel;
a circuitry; and
a memory to store instructions that, when executed by the circuitry, cause the LiDAR system to:
determine a frequency of a crosstalk signal in a detection of the second signal based on the first signal;
determine an intensity of the crosstalk signal based on an intensity of the first signal; and
provided the intensity of the crosstalk signal is in a detectable range, exclude the crosstalk signal from the detection of the second signal to produce a corrected second signal, to extract the at least one of range or velocity information related to a target based on the corrected second signal.
